(19) United States
(12) Patent Application Publication
(10) Pub. No.: US 2009/0172165 A1
(43) Pub. Date: Jul. 2, 2009

(54) Information Processing Apparatus and Information Processing System

(75) Inventors: Tsutomu Rokuhara, Tama-shi (JP); Hiroshi Oshikiri, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/327,747

(22) Filed: Dec. 3, 2008

(30) Foreign Application Priority Data
Dec. 27, 2007 (JP) 2007-338218
Apr. 24, 2008 (JP) 2008-114237

(51) Int. Cl. G06F 15/173

(52) U.S. Cl. 709/226

(57) ABSTRACT

According to one embodiment, an information processing apparatus includes a monitor module configured to control and simultaneously operate a plurality of software resources executed on the operating system on one hardware resource, one of the software resources is a server software resource operated as a server, a one of the software resources is a client software resource utilizing service of the server software resource, the hardware resource has a user disk space in which data used by the client software resource is stored, and the server software resource has an access right control module which attempts to communicate with a management server connected via a network when the client software resource is started, acquires an key from the management server, authenticates the acquired key, and provides a right of access to the user disk space for the client software resource when it is determined that the key is valid.

### CROSS-REFERENCE TO RELATED APPLICATIONS

This application is based upon and claims the benefit of priority from Japanese Patent Applications No. 2007-338218, filed Dec. 27, 2007; and No. 2008-114237, filed Apr. 24, 2008, the entire contents of both of which are incorporated herein by reference.

### BACKGROUND

1. Field

One embodiment of the invention relates to an information processing apparatus and information processing system that utilize the virtual monitoring technique.

2. Description of the Related Art

Conventionally, access can be normally made to a disk in which individual data is stored under the management of only a user OS. However, this causes a problem that unapproved information or the like stored in an individual data disk will be supplied to a third person who is dishonest irrespective of the intentional or unintentional operation by the user if the user uses a PC without connecting the PC to a management server and a serious problem may occur in the business activities and the like in some cases.

in Jpn. Pat. Appln. KOKAI Publication No. 2000-112804, a method for setting an operating system capable of accessing various files in a virtual computer system to protect the files is disclosed.

With the above technique, a large number of disk resources are required in order to set an operating system capable of accessing various files.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing the configuration of an information processing system according to one embodiment of this invention.

FIG. 2 is an exemplary flowchart for illustrating the procedure of an authentication process performed between a client PC and a management server.

FIG. 3 is an exemplary diagram showing a state in which a Keep Alive process in an information processing system according to one embodiment of this invention is performed.

FIG. 4 is an exemplary flowchart for illustrating the procedure of the Keep Alive process.

FIG. 5 is an exemplary diagram showing a state in which a user disk space is replaced by a check-out disk space by means of the management server.

FIG. 6 is an exemplary flowchart for illustrating the procedure of replacing the user disk space by the check-out disk space.

FIG. 7 is an exemplary diagram showing a state in which an access level to the user disk space is changed.

FIG. 8 is an exemplary flowchart for illustrating the procedure of changing the access level to the user disk space.

FIG. 9 is an exemplary diagram showing a state in which a plurality of user disk spaces are provided in the user system and access levels are respectively set therein.

FIG. 10 is an exemplary diagram showing a state in which an access key is stored in a storage device and an authentication process is performed.

FIG. 11 is an exemplary flowchart for illustrating the procedure of performing an authentication process by using the access key stored in the storage device.

FIG. 12 is an exemplary diagram showing the schematic configuration of an information processing system according to one embodiment of this invention.

FIG. 13 is an exemplary flowchart for illustrating the procedure of a process of causing the management server to form file list information.

FIG. 14 is an exemplary flowchart for illustrating the procedure of an update process of file list information.

FIG. 15 is an exemplary flowchart for illustrating the procedure of causing the user on a client PC to remote-access a file on the user disk of the client PC of another user in the same group.

### DETAILED DESCRIPTION

Various embodiments according to the invention will be described hereinafter with reference to the accompanying drawings. In general, according to one embodiment of the invention,

1. An information processing apparatus comprises a monitor module configured to control and simultaneously operate a plurality of software resources each containing an operating system, data and a program executed on the operating system on one hardware resource, one of the software resources operated on the hardware resource of the information processing apparatus is a server software resource operated as a server, a different one of the software resources operated on the hardware resource of the information processing apparatus is a client software resource utilizing service of the server software resource, the hardware resource has a user disk space in which data used by the client software resource is stored, and the server software resource has an access right control module which attempts to communicate with a management server connected via a network when the client software resource is started, acquires an access key from the management server, authenticates the acquired access key, and provides a right of access to the user disk space for the client software resource when it is determined that the access key is valid.

There will now be described embodiments of this invention with reference to the accompanying drawings.

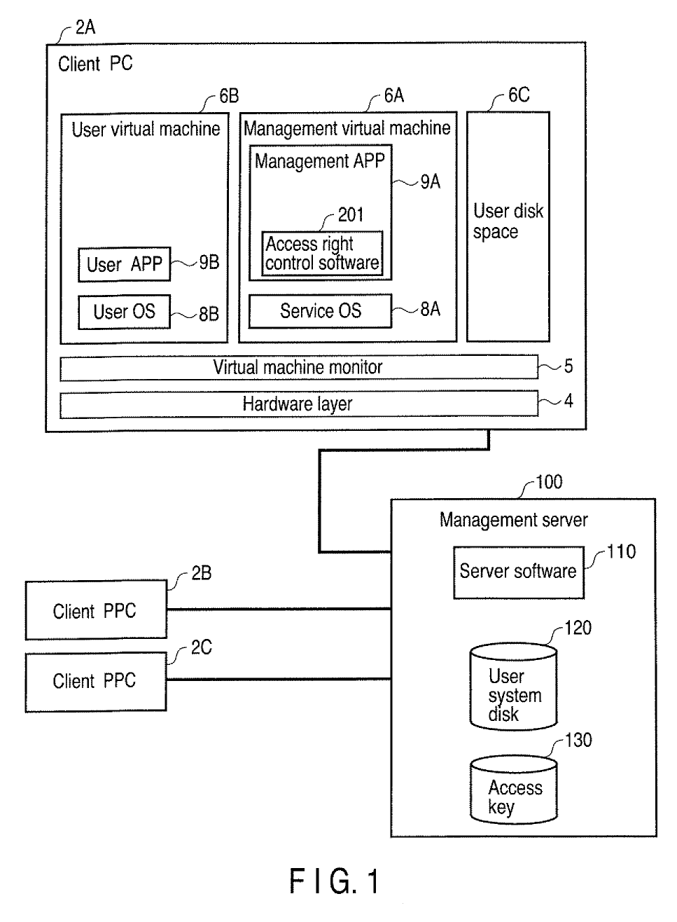

As shown in FIG. 1, a plurality of client PCs 2A to 2C are connected to a management server 100.

The management server 100 has a user system disk 120 installed on a client PC and executed as a user virtual machine and a server software 110 that performs a control function in order to communicate with the client PCs 2A to 2C.

In the client PCs 2A to 2C, an environment that realizes a virtual monitoring technique provided by, for example, XEN, VMWARE or the like is provided. User system spaces contained in the client PCs 2A to 2C are process areas that can be directly operated by operating the keyboard by the user and are provided by a user OS (Windows XP, Vista, for example), various client software, system settings, security policy or the like stored in the user system disk 120. The client PCs 2B, 2C have the same configuration as the client PC 2A and the drawing thereof is omitted.

The client PC 2A has a hardware layer 4, virtual machine monitor 5, management virtual machine (server software resource) 6A, user virtual machine (client software resource) 6B, user disk space 6C and the like.

The hardware layer 4 has a display, hardware disk drive (HDD), network interface card, keyboard, mouse and the like.

The virtual machine monitor 5 manages the hardware layer 4 and allocates resources for the respective virtual machines 6A, 6B. Further, the virtual machine monitor 5 distributes an execution schedule of the virtual machine and an I/O request from the virtual machine to the hardware layer 4.

The management virtual machine 6A includes a service operating system (service OS) 8A, management application 9A and the like. The service operating system 8A is an operating system that operates the management application 9PA. For example, Linux is used as the service operating system 8A. An access right control software 201 is an application used to control access from the user virtual machine 6B to the user disk space 6C.

The user virtual machine 6B includes a user operating system (user OS) 8B, user application 9B and the like. The user operating system 8B is an operating system that provides an environment generally used by the user. In general, as the user operating system 8B, a Windows series operating system is used. The user application 9B is application software operated on the user operating system 8B. For example, it is a word processor, spreadsheet software/presentation data creation software, mailer, Web browser or the like.

The user virtual machine 6B cannot look at data in the management virtual machine 6A and cannot directly access the data.

The user disk space 6C is a space allocated in the hard disk drive. In the user disk space 6C, data created by using the user application 9B or data that can be read is stored.

The management virtual machine 6A contained in each of the client PCs 2A to 2C is a process area that performs the following processes by use of the service operating system 8A and the management application 9A operated thereon.

(a) the process of providing an individual data disk to the user system,

(b) the process of opening or closing the user system space,

(c) the process of replacing the user system disk, and

(d) the process of communicating with the management server placed on the remote location and attaining cooperation with the processes (a) and (b)

As one example, suppose that the controller on the management server detects that patch information, system setting information, security policy and revisions of various user software of windows on the client PC lying on a remote portion and connected to the network are different from corresponding information items in the user system disk held on the management server for a client PC in which a virtual machine monitor is provided by XEN, the user system space (user virtual machine) (Domain-U) is a windows OS and Domain-0 is a service system space (management virtual machine). Then, in cooperation with the service software (corresponding to the access right control software 201) on Domain-0 on the client PC, the controller closes (shuts down) Domain-U when it is open and rewrites the user system disk to a use system disk on the management server and opens (wakes up) Domain-U again when it is previously closed. By performing the above operation with respect to one or more client PCs on the system, the manager can unify the security policy of the client PC in the system.

Next, access from the user virtual machine 6B to the user disk space 6C is explained.

The virtual machine monitor 5 monitors access from the user virtual machine 6B to the user disk space 6C. If access from the user virtual machine 6B to the user disk space 6C occurs, the virtual machine monitor 5 permits access from the user virtual machine 6B to the user disk space 6C when the access right control software 201 provides the right of access to the user disk space 6C for the user virtual machine 6B.

When the user virtual machine 6B is started, the access right control software 201 attempts to communicate with the management server 100. If the communication is successfully performed, the access right control software 201 requests the server software 110 to transmit an access key 130. Then, the access right control software 201 performs an authentication process for the access key 130 transmitted from the server software 110. If the authentication process is successfully performed, the access right control software 201 informs the virtual machine monitor 5 that the right of access to the user disk space CC is given to the user virtual machine 6B. If the authentication process is performed in failure, the access right control software 201 does not inform the virtual machine monitor 5 that the right of access to the user disk space 6C is given to the user virtual machine 6B.

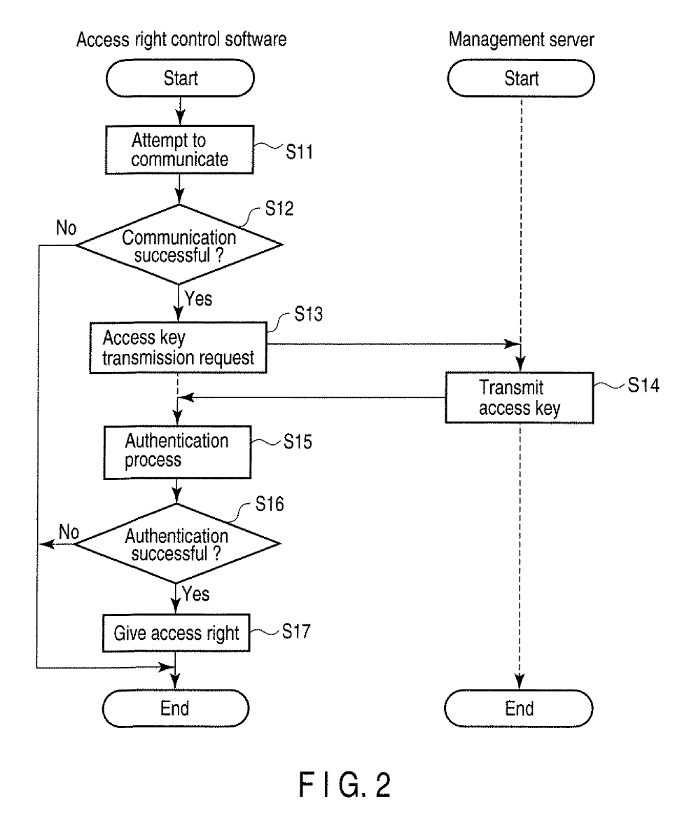

The above process is explained with reference to the flowchart of FIG. 2.

The access right control software 201 attempts to communicate with the management server 100 (block S11). If the communication is successfully performed (YES in block S12), the access right control software 201 requests the server software 110 to transmit an access key 130 (block S13). The management server 100 transmits the access key 130 in response to the request (block S14). Then, the access right control software 201 performs an authentication process to determine whether the received access key 130 is valid or not (block S15).

If the authentication process is successfully performed (YES in block S16), the access right control software 201 provides the right of access to the user disk space 6C for the user virtual machine 6B (block S17).

Thus, the access right control software 201 performs an authentication process for the access key 130 provided by the management server 100 and provides the right of access to the user disk space 6C for the user virtual machine 6B if the authentication process is successfully performed. As a result, it becomes possible to prevent occurrence of leakage of secret information data and the like by check-out in an unapproved state without the necessity of having a large number of disk resources.

For example, suppose that a client PC in which a virtual machine monitor is provided by XEN and a service system space (management virtual machine) of Domain 0 holds the user disk space 6C as a virtual disk image is provided. When the service software (corresponding to the access right control software 201) in the service system attempts to acquire an access key for the management server and can acquire an access key in a preset period of time and it is determined that the access key is valid, then the service software of Domain 0 of XEN executes a script in which a file or disk name is described in which the above virtual disk image is present on an XEN script used to start the user system (Domain-U). Thus, an individual disk is provided at the starting time of the user system.

[Keep Alive Process]

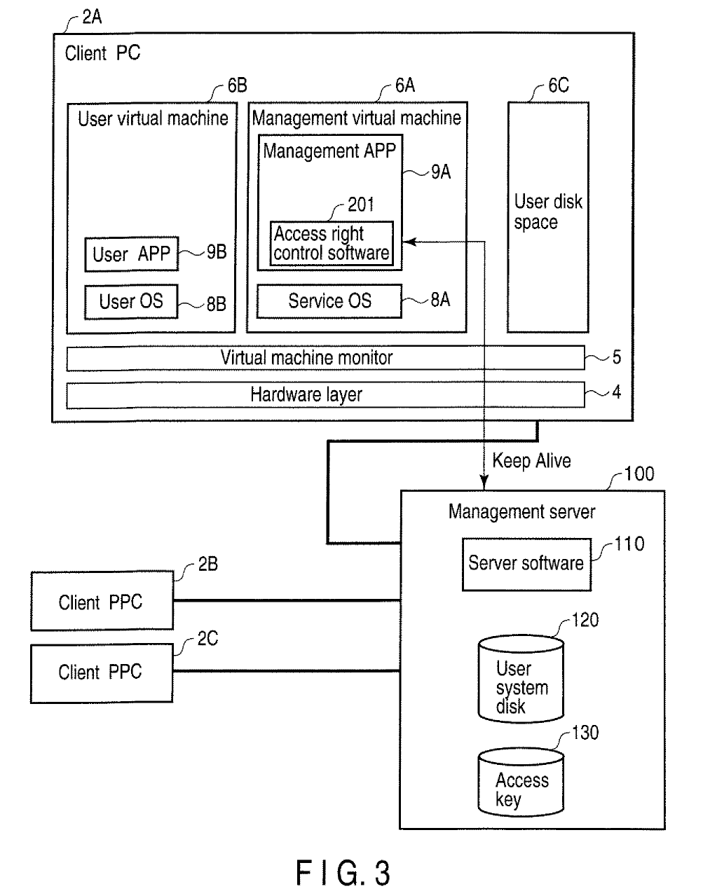

As shown in FIG. 3, the access right control software 201 performs communication (Keep Alive) with the management server 100 for a preset period of time and determines whether connection with the management server 100 is effective or not. Then, the access right control software 201 dynamically suspends or resumes provision of the right of access to the user disk space 6C for the user virtual machine 6B according to the determination state.

When the access right control software 201 determines that no response is issued from the management server 100 for a preset period of time, it suspends provision of the right of access to the user disk space 6C for the user virtual machine 6B. After this, the access right control software 201 continuously attempts to perform the Keep Alive process with respect to the management server 100, and if a response from the management server 100 is recovered, it resumes provision of the access right to the user disk space 6C for the user virtual machine 6B.

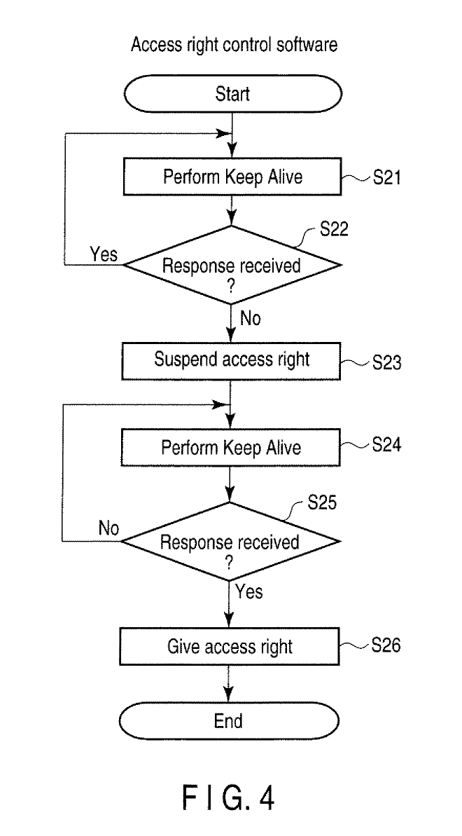

The above process is explained with reference to the flowchart of FIG. 4.

The access right control software 201 performs communication (Keep Alive) with the management server 100 for a preset period of time (block S21). If no response is issued from the management server 100 (NO in block S22), the access right control software 201 suspends provision of the access right to the user disk space 6C for the user virtual machine 6B (block S23).

After this, the access right control software 201 performs communication (Keep Alive) with the management server 100 for a preset period of time (block S24). If a response is issued from the management server 100 (YES in block S25), the access right control software 201 provides the access right to the user disk space 6C for the user virtual machine 6B (block S26).

Thus, it is possible to prevent occurrence of leakage of secret information data and the like by suspending provision of the access right if the communication with the management server 100 is interrupted even when the client PC 2A is carried out after authentication.

For example, suppose that a client PC in which a virtual machine monitor is provided by XEN, a service system (management virtual machine) is Domain-0 and the user system Domain-U (user virtual machine) is windows XP is provided if the service software (corresponding to the access right control software 201) in the service system on the client PC determines that no response in the Keep Alive process with the management server is issued, it interrupts the virtual disk IO driver to the individual data disk (user disk space) on the user system (Domain-U). At this time, a drive having an individual data disk mounted thereon is detected to be disconnected (Plug Out) from Windows and then access to the individual data disk by the user can be made impossible. After this, if the service software determines that the Keep Alive process with the management server is resumed, the above virtual disk IO driver of Domain-U is opened again. At this time, Windows detects (Plug In) that a drive having an individual data disk mounted thereon is connected (Plug In) and connection to the individual data disk can be made possible.

[Replacement of disk Space at Time of Check-out of Client PC]

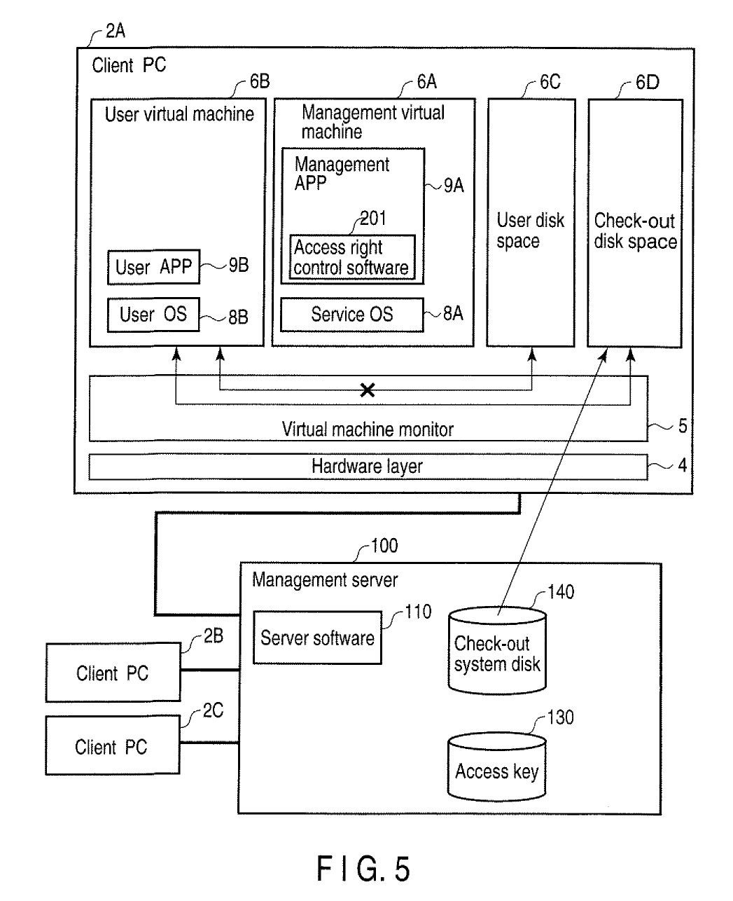

FIG. 5 shows a state in which the user disk space 6C is replaced by a check-out disk space 6D by means of the management server 100. When the user carries out the client PC 2A to the exterior and discloses data to another person, there occurs possibility that secret information may be contained in the user disk space 6C and information may be leaked by looking into or losing the information in some cases.

In order to solve the above problem, the manager prepares a virtual check-out disk 140 having one or more data items on the management server 100.

When checking out the client PC 2A to the exterior, the user requests the management server 100 to make preparation for checking out the client PC. The management server 100 forms a check-out disk space 6D in the client PC 2A in cooperation with the access right control software 201 that is operated in the management virtual machine 6A on the client PC 2A in response to the request from the user and stores data in the check-out disk 140 in the check-out disk space 6D. The access right control software 201 replaces the disk space utilized by the user virtual machine 6B from the user disk space 6C to the check-out disk space 6D.

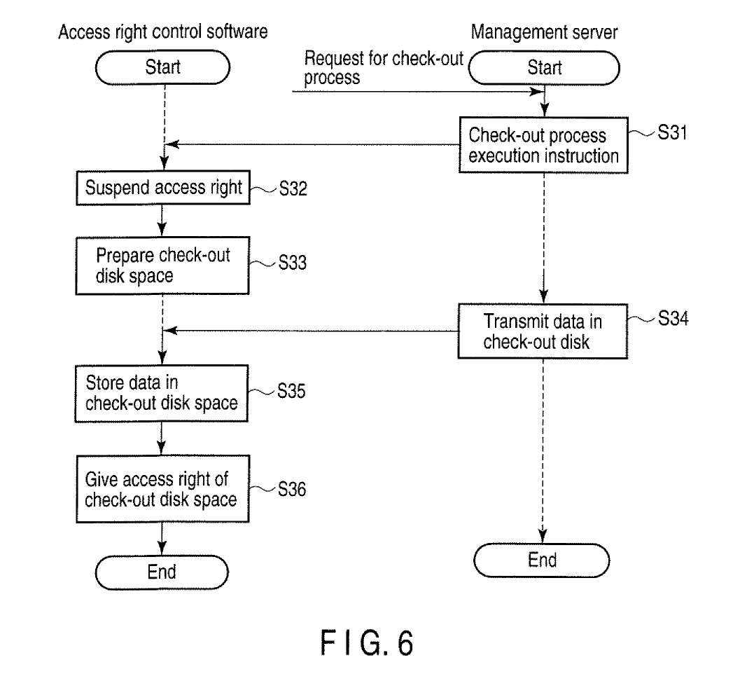

The procedure of the above process is explained with reference to the flowchart of FIG. 6.

The user requests the management server 100 to perform the check-out process of the client PC 2A. For example, the request is transmitted from the user virtual machine 6B. The management server 100 transmits a check-out process execution instruction to the access right control software 201 (block S31)

The access right control software 201 suspends the access right to the user disk space 6C that has been given to the user virtual machine 6B in response to the request (block S32). Then, it prepares a check-out disk space 6D (block S33). The management server 100 transmits data in the check-out disk 140 to the access right control software 201 (block S34).

The access right control software 201 stores data in the check-out disk 140 transmitted from the management server 100 to the check-out disk space 6D (block S35). Then, the access right control software 201 gives the access right of the check-out disk space 6D to the user virtual machine 6B (block S36). The right of access to the check-out disk space 6D is given without performing the authentication process for the access key 130 in the management server 100 even after restarting.

When the user carries out the client PC 2A to the exterior and disk loses data to another person, leakage of secret information data or the like can be prevented by preparing a check-out disk space 6D containing no secret information and giving the access right to the user virtual machine 6B.

For example, suppose that a client PC in which a virtual machine monitor is provided by XEN, a service system (management virtual machine) is Domain-0 and a user system Domain-U (user virtual machine) is Windows XP is provided. The service software (corresponding to the access right control software 201) in the service system on the client PC first acquires a request for replacement of the individual data disk (user disk space) from the management server. If Domain-U is present, the service software closes the same, receives a check-out management disk that is a virtual disk image from the management server. Further, it rewrites the file name or disk name of the individual data disk in the Domain-U script provided by XEN and restarts (opens) Domain-U by use of Domain-0 when required.

[Access Level Change at Check-out Time of Client PC]

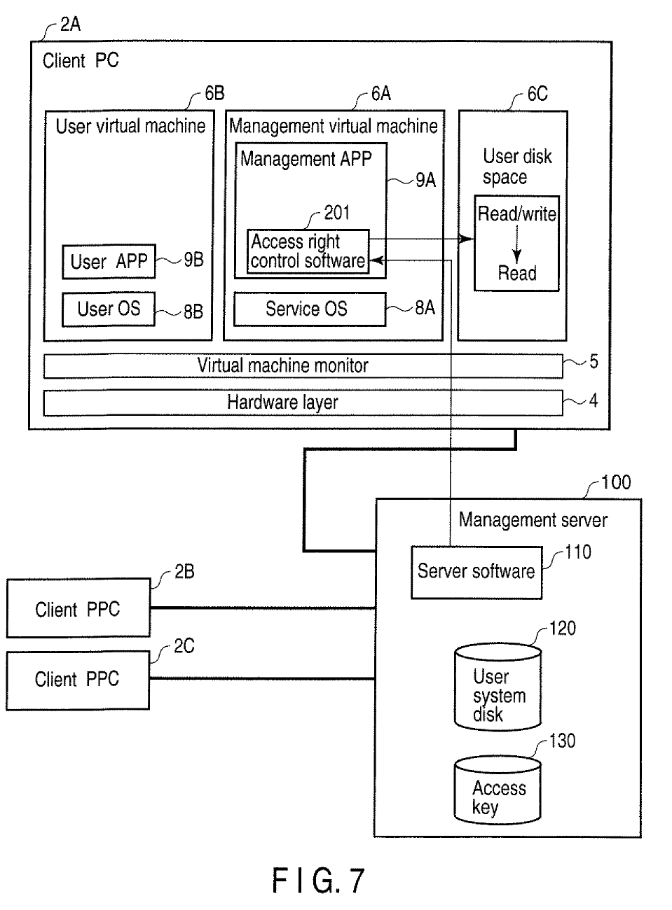

FIG. 7 shows a state in which an access level (Read right/Write right) to the user disk space 6C can be set from the server software 110 executed on the management server 100.

When the client PC 2A is carried out to the exterior, the user requests the management server 100 to make preparations for the check-out process. The server software 110 executed on the management server replaces the access level of the user disk space 6C from the (Read+Right) right to the Read right in cooperation with the access right control software 201 executed in the management virtual machine 6A in response to the request.

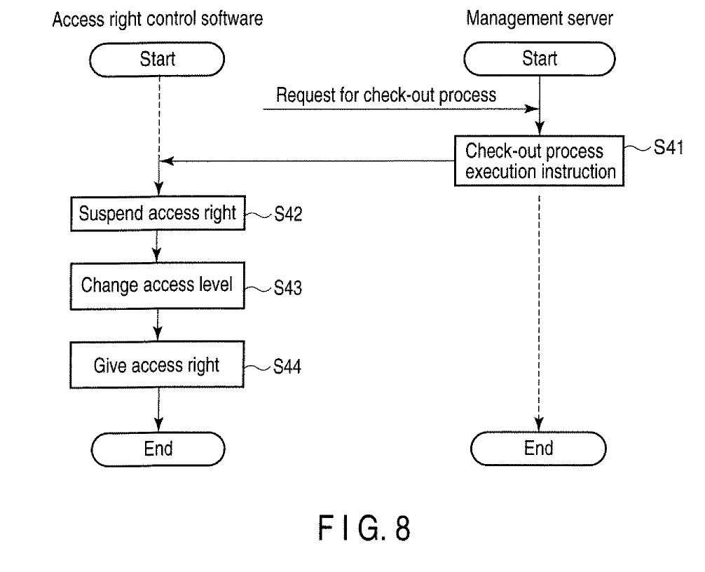

The procedure of the above process is explained with reference to the flowchart of FIG. 8.

The user requests the management server 100 to perform the check-out process of the client PC 2A. For example, the request is transmitted from the user virtual machine 68. The management server 100 transmits a check-out process execution instruction to the access right control software 201 (block S41).

The access right control software 201 suspends the access right to the user disk space 6C that has been given to the user virtual machine 6B in response to the request (block S42). Then, the access right control software 201 replaces the access level of the user disk space 6C to the user virtual machine 6B from the (Read +Wright) right to the Read right (block S43). After this, the access right control software 201 provides the access right to the user disk space 6C for the user virtual machine 6B.

The access right of the user disk space 6C in which the access level is set only to the Read right is provided without performing the authentication process for the access key 130 in the management server 100 even after restarting.

Based on the above fact, it is possible to prevent the process of providing information falsified by the user for another person and the dishonest process by the user to store secret information or the like of another person on an individual data disk irrespective of the intentional or unintentional operation when the user carries out the client PC 2A to the exterior.

For example, suppose that a client PC in which a virtual machine monitor is provided by XEN, a service system (management virtual machine) is Domain-0 and a user system Domain-U (user virtual machine) is windows XP is provided. The service software (corresponding to the access right control software 201) in the service system on the client PC first receives an access right change request with respect to the user disk space 6C from the management server 100. If Domain-U is present, the service software closes the same, changes the setting of the access level of the file name or disk name (from (Read+Write) to Read) of the individual data disk in the Domain-U script provided by XEN and restarts (opens) Domain-U by use of Domain-0 when required.

[Plural User Disk Spaces]

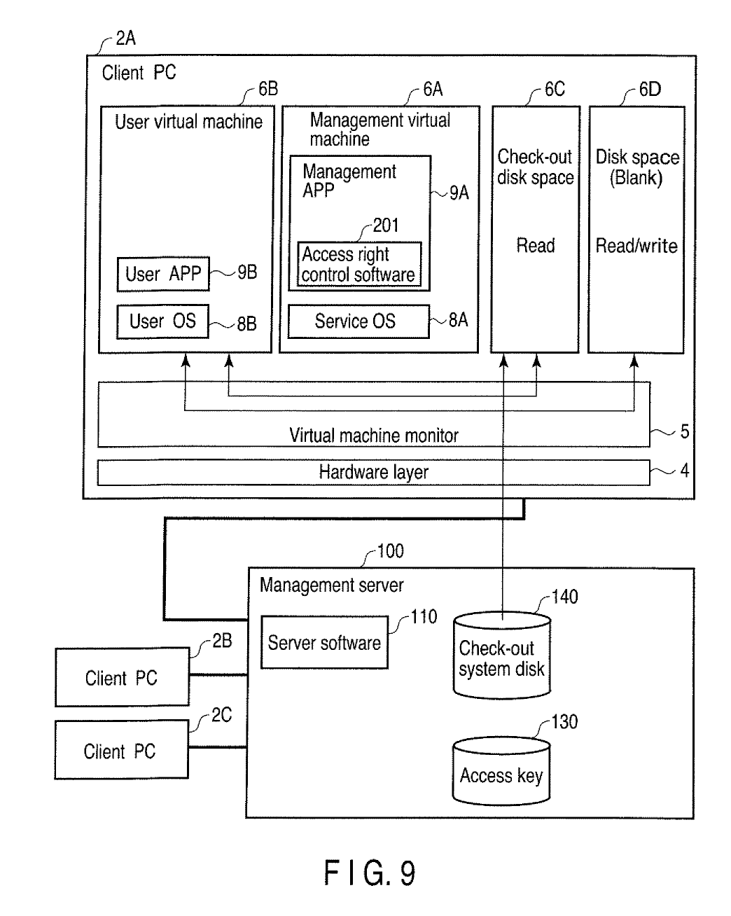

FIG. 9 shows a state in which the access right control software 201 prepares a plurality of user disk spaces to which respective access levels are set and gives the access right to the user virtual machine 6B. For example, when the user goes out, a check-out disk space 6D having only the Read right given from the management server and a disk space 6E of blank data having the (Read+Write) right are provided.

Therefore, only information that can be disclosed at the going-out time is provided from the check-out disk space 6D to another person and acquired necessary information can be stored in the disk space 6E. According to the above fact, the effect of preventing information containing both of the disclosed information and acquired information from being erroneously used in the carried-out client PC can be attained unlike a case wherein one user disk space is provided.

[Copy of Access Key]

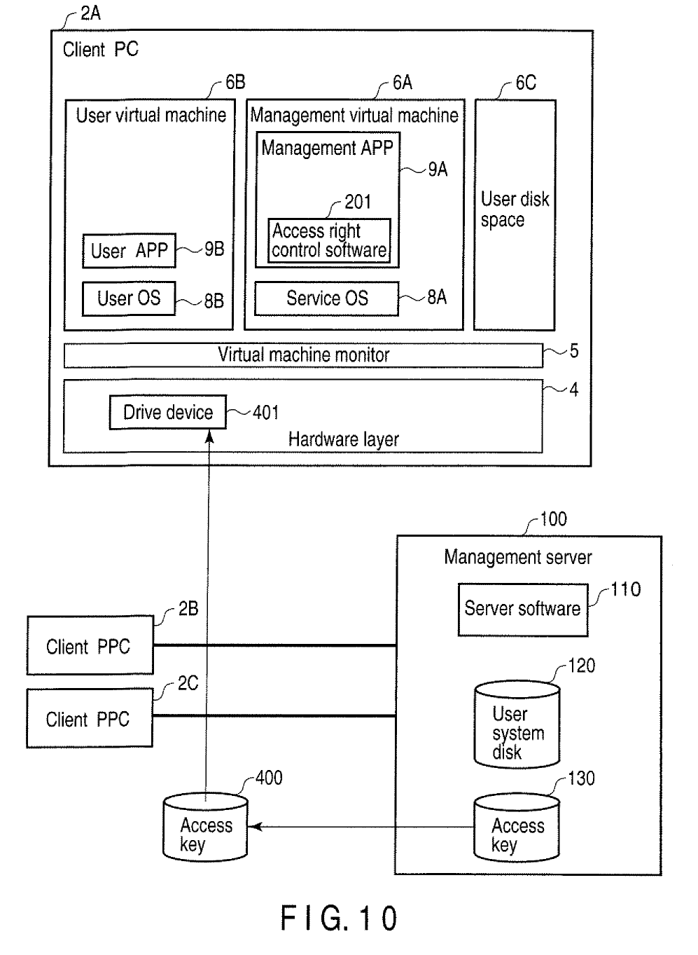

FIG. 10 shows a state in which an access key is distributed not via a network but via a removable storage device (SD card, USB memory) 400 in a case where the access key is distributed from the management server when the client PC 2A is carried out to the exterior.

In the method shown in FIG. 1, when the client PC 2A is carried out to an environment in which it can physically access the management server 100, it becomes impossible for the user to access the user disk space 6C. In order to avoid this, the manager copies an access key of the to-be-carried-out client PC 2A on the management server 100 to the storage device 400 and the user who acquires the storage device inserts the storage device into a drive device 401 on the client PC 2A. Then, the access right control software 201 performs the authentication process and, as a result, the user disk space 6C can be provided for the user virtual machine 6B.

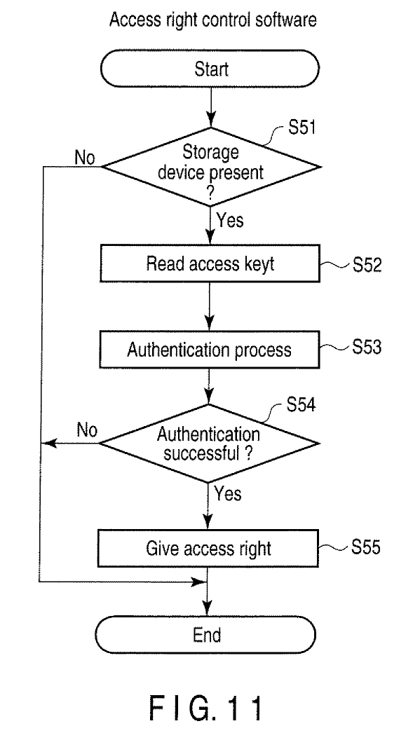

The above process is explained with reference to the flowchart of FIG. 11.

When an attempt is made to communicate with the management server 100 and if the communication cannot be made (corresponding to NO in block S12 of FIG. 2), the access right control software 201 detects whether or not the storage device 400 in which the access key is stored is inserted into the drive device 401 (block S51). If it is not detected (NO in block S51), the access right control software 201 terminates the process.

If it is detected (YES in block S51), the access right control software 201 reads an access key from the storage device 400 (block S52). Then, the access right control software 201 performs an authentication process to determine whether the read access key is valid or not (block S53).

If the authentication process is successfully performed (YES in block S54), the access right control software 201 provides an access right to the user disk space for the user virtual machine 6B (block S55) If the authentication process is performed in failure (NO in block S54), the access right control software 201 terminates the process.

For example, suppose that a client PC in which a virtual machine monitor is provided by XEN, a service system (management virtual machine) is Domain-0 and a user system Domain-U (user virtual machine) is Windows XP is provided. The user turns on the power source of the client PC carried out to the exterior by the user in a state in which the client PC is not connected to the network. First, the service system space (Domain-0) is started and the service software (corresponding to the access right control software 201) in the service system checks whether or not it can communicate with the management server. If the communication cannot be performed, whether or not a physical medium having the access key stored in the drive on the virtual PC is checked. When it is determined that the physical medium is present and the access key stored in the physical medium is valid, the service system executes an XEN script containing a device or virtual disk image on Domain-0 configuring the individual data disk and Domain-U (Windows) is started with the individual data disk supplied from the service system.

[File List Information]

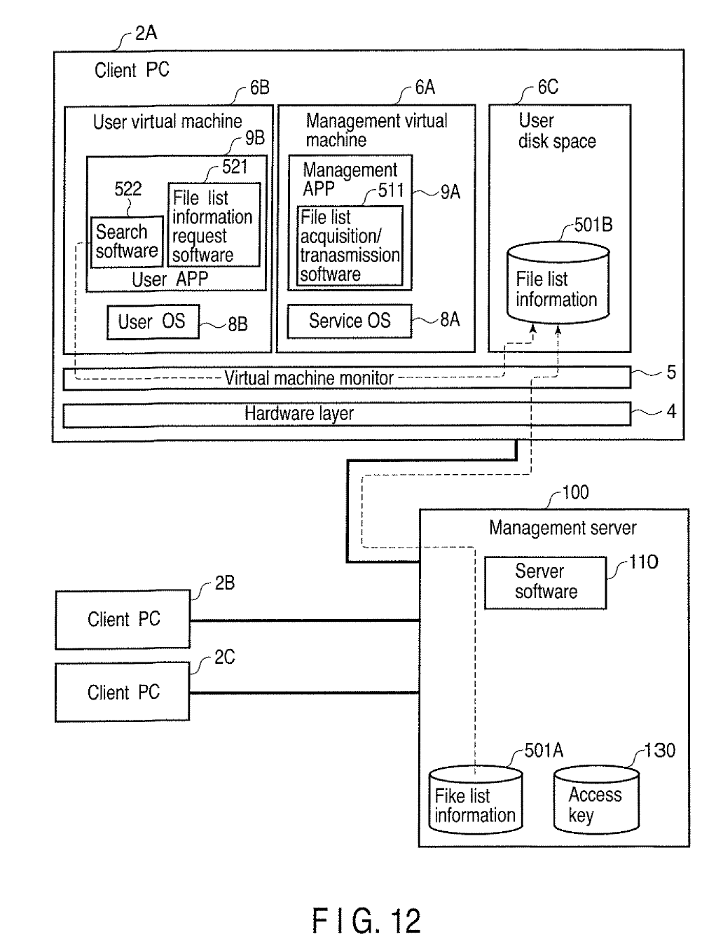

FIG. 12 is a diagram showing the schematic configuration of an information processing system according to one embodiment of this invention. In FIG. 12, portions that are the same as those of FIG. 1 are denoted by the same reference symbols and the explanation thereof is omitted.

The server software 110 of the management server 100 creates file list information 501A in which information items of the user who uses the user disk space 6C having files stored therein and passes (containing file names) of respective files stored in the user disk spaces 6C of the client PCs 2A to 2C connected to the management server 100 via the network are registered. In the file list information 501A, text information in the file can be registered.

The server software 110 instructs file list acquisition/transmission software 511 which is one of management applications 9A to transmit a list of files stored in the user disk space 6C and creates file list information 501A based on the file lists of the client PCs 2A to 2C transmitted based on the instruction. The file list acquisition/transmission software 511 accesses the user disk space 6C to acquire a list of files based on the request from the server software 110.

Then, the server software 110 performs a process of creating file list information 501B that is a copy of the file list information 501A in the user disk space 6C of a requested one of the client PCs 2A to 2C according to the request from file list information request software 521 that is one of user applications 9B executed in the user virtual machines 65 of the client PCs 2A to 2C.

Search software 503 used as the user application 9B searches for a keyword by using the file name or text information or the like in the file from the file list information 501B.

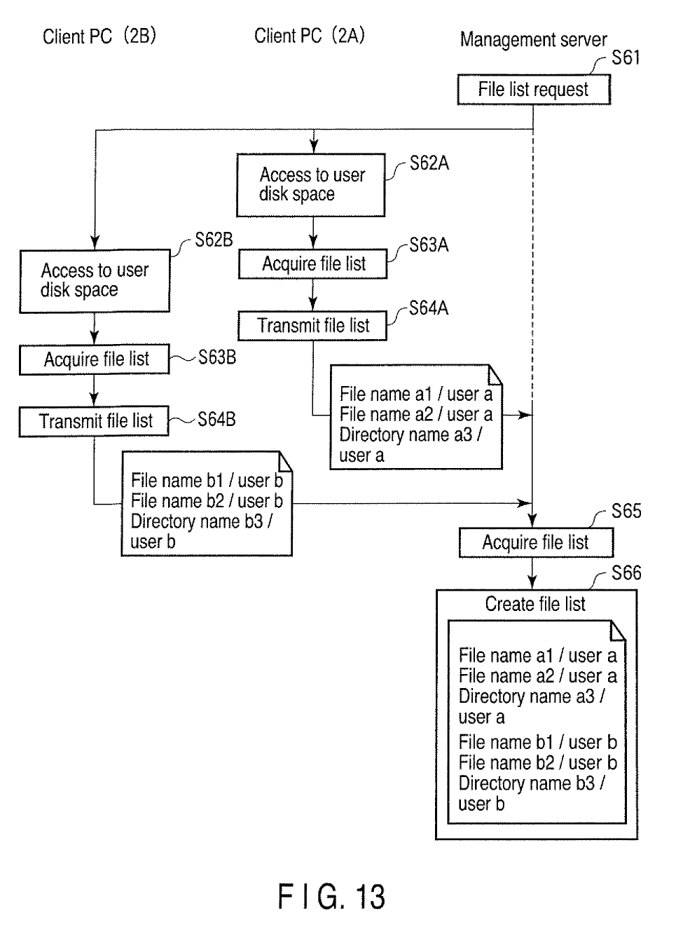

Next, the procedure of the process of creating file list information by use of the management server 100 is explained with reference to the flowchart of FIG. 13.

The server software 110 executed on the management server 100 requests the file list acquisition/transmission software 511 of each of the client PCs 2A to 2C to transmit a file list (block S61). The file list acquisition/transmission software 511 of the client PCs 2A, 2B respectively access the user disk spaces 6C thereof (blocks S62A, S62B) and acquire lists of passes of the files stored in the respective user disk spaces 6C (blocks S63A, 63B). Then, the thus acquired lists of the passes of the files are transmitted to the management server 100 together with the user names (blocks S64A, 645). The management server 100 acquires the list of the passes of the files of each client PC (block S65) to create file list information 501A (block S66).

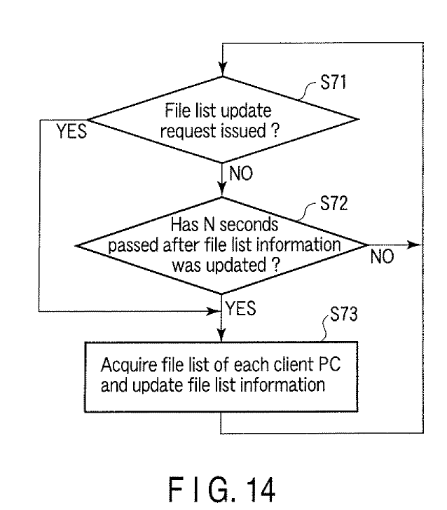

As shown in the flowchart of FIG. 14, the server software 110 performs an update process of the file list information periodically or when a request is issued from the user.

The process shown by the flowchart of FIG. 14 is explained below. The server software 110 determines whether or not a file list update request is issued from the client PCs 2A to 2C (block S71). If it determines that no request is issued (NO in block S71), whether or not a time of N seconds has elapsed after the file list was last created (block S72). If it is determined that a time of N seconds is not passed (NO in block S72), the process of block S71 is performed after a preset period of time has elapsed. If it determines in block S71 that a request is issued (YES in block S71) or if it is determined in block S72 that a time of N seconds is passed (YES in block S72), the server software 110 acquires the list of the file from each client PC and performs a file list information update process (block S73).

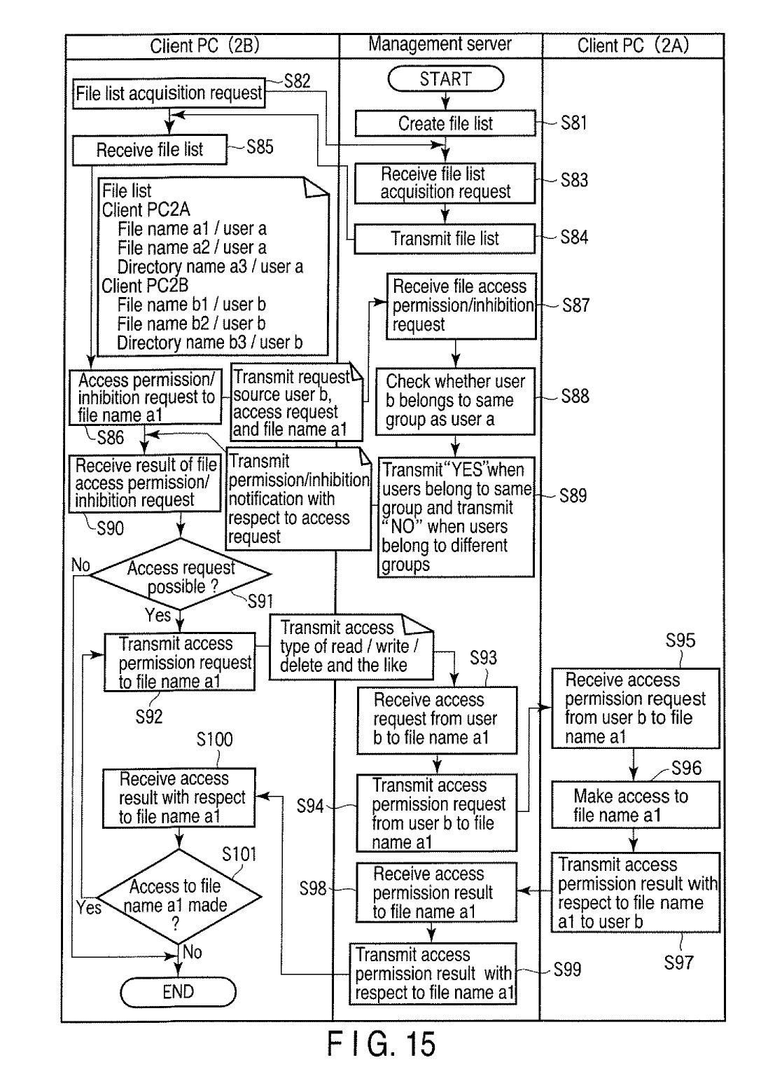

Next, the procedure in which the user on the client PC 2B remotely accesses a file on the user disk of the client PC 2A of another user belonging to the same group is explained with reference to the flowchart of FIG. 15.

First, the server software on the management server previously creates one group configured by one or more users. Then, file list information 501A is created on the management server 100 by use of the method of FIG. 13 (block S81).

File list information request software 521 executed in the client PC 2B transmits a file list acquisition request to the management server 100 (block S82). When receiving the acquisition request (block S83), the server software 110 of the management server 100 transmits file list information 501A to the user disk space 6C of the client PC 2B (block S84). The client PC 2B creates file list information 501B in the user disk space 6C based on the received data (block S85).

Next, a case wherein the user who uses the client PC 2B wants to access a file name al stored in the user disk space 6C of the client PC 2A searched for by use of the search software 503 from the file list information 501B is explained.

The user application 9B of the client PC 2B transmits an access permission/inhibition request containing a request source user name and the pass of the file name al to the management server 100 in response to the operation by the user (block S86) When receiving the access permission/inhibition request (block S87), the management server 100 determines whether or not the request source user name (user b) belongs to the same group in which the user a who is the user of the client PC 2A in which the file a1 is stored (block S88). The management server 100 transmits a permission/inhibition notification with respect to the access request corresponding to the determination result to the client PC 2B (block S89) The management server 100 transmits “YES” when the user b and the user a belong to the same group and transmits “NO” when the users belong to different groups.

When receiving the permission/inhibition notification (block S90), the user application 9B of the client PC 2B determines whether access can be made or not (block S91). If it is determined that access cannot be made (NO in block S91), the client PC 2B terminates the access process relating to the file name al. If it is determined that access can be made (YES in block S91), the user application 9B of the client PC 2B transmits an access request corresponding to the access type to the management server 100 (block S92). When receiving an access request from the user b to the file name al (block S93), the management server 100 transmits an access permission request from the user b to the file name al to the client PC 2A (block S94).

When receiving the access permission request (block S95), the client PC 2A makes access to the file name al (block S96). The client PC 2A transmits an access permission result to the file name al addressed to the user b to the management server 100 (block S97)

When receiving the access permission result (block S98), the management server 100 transmits an access permission result with respect to the file name al addressed to the user b to the client PC 2B (block S99). When receiving the access result to the file name al (block S100), the client PC 2B determines whether access to the file name al is made or not (block S101). When the access is made (YES in block S101), the process returns to block S92 and then an access permission request is transmitted again. Further, if the access is not made (NO in block S101), the process is terminated.

According to the above system, the effect that a small amount of disk resources can be effectively utilized without using a file server of large capacity can be attained by acquiring a file list stored in the user disk space 6C on each client PC or performing a search process by using acquired information, permitting common access to the user disk space 6C of another client PC belonging to the same group.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a monitor module configured to control and simultaneously operate a plurality of software resources each containing an operating system, data and a program executed on the operating system on one hardware resource, one of the software resources operated on the hardware resource of the information processing apparatus is a server software resource operated as a server, a different one of the software resources operated on the hardware resource of the information processing apparatus is a client software resource utilizing service of the server software resource, the hardware resource has a user disk space in which data used by the client software resource is stored, and the server software resource has an access right control module which attempts to communicate with a management server connected via a network when the client software resource is started, acquires an access key from the management server, authenticates the acquired access key, and provides a right of access to the user disk space for the client software resource when it is determined that the access key is valid.

2. The information processing apparatus of claim 1, wherein the access right control module periodically attempts to communicate with the management server to confirm the presence of the management server and takes away the right of access to the user disk space from the client software resource if the communication with the management server is not successfully made.

3. The information processing apparatus of claim 2, wherein the access right control module periodically attempts to communicate with the management server to confirm the presence of the management server after the communication with the management server is not successfully made and the access right control module provides the right of access to the user disk space for the client software resource if the communication with the management server is successfully made.

4. The information processing apparatus of claim 1, wherein the access right control module sets an access level of the client software resource with respect to the user disk space to a Read right in response to a request of the user and provides a right of access to the user disk space for the client software resource without performing an authentication process for the access key.

5. The information processing apparatus of claim 4, wherein the access right control module prepares a second user disk space, sets an access level of the client software resource with respect to the user disk space to a Read right/Write right and provides a right of access to the second user disk space for the client software resource without performing an authentication process for the access key.

6. The information processing apparatus of claim 1, further comprising a read module configured to read data from a removable storage device in which a copy of a removable access key is stored,
wherein the access right control module reads the access key from the removable storage device, performs an authentication process for the read access key and provides a right of access to the user disk space for the client software resource if it is determined that the access key is valid.

7. The information processing apparatus of claim 1, wherein the access right control module is supplied with data from the management server in response to a request from the user and provides a right of access to a third user disk space in which the data is stored for the client software resource.

8. An information processing system comprising:
a management server having an access key; and
an information processing apparatus connected to the management server via a network, having a monitor module configured to control and simultaneously operate a plurality of software resources each containing an operating system, data and a program executed on the operating system on one hardware resource, one of the software resources operated on the hardware resource of the information processing apparatus being a server software resource operated as a server, the hardware resource having a user disk space in which data used by the client software resource is stored, a different one of the software resources operated on the hardware resource of the information processing apparatus being a client software resource utilizing service of the server software resource, and the server software resource having an access right control module which attempts to communicate with the management server connected via a network when the client software resource is started, acquiring an access key from the management server and authenticates the acquired access key when the communication with the management server is successfully made, and provides a right of access to the user disk space for the client software resource when it is determined that the access key is valid.

9. The information processing system of claim 8, wherein the access right control module periodically attempts to communicate with the management server to confirm the presence of the management server and takes away the access right to the user disk space from the client software resource if the communication with the management server is not successfully made.

10. The information processing system of claim 9, wherein the access right control module periodically attempts to communicate with the management server to confirm the presence of the management server after the communication with the management server is not successfully made and provides the right of access to the user disk space for the client software resource if the communication with the management server is successfully made.

11. The information processing system of claim 8, wherein the access right control module sets an access level of the client software resource with respect to the user disk space to a Read right in response to a request from the user and provides a right of access to the user disk space for the client software resource without performing an authentication process for the access key.

12. The information processing system of claim 11, wherein the access right control module prepares a second user disk space, sets an access level of the client software resource with respect to the user disk space to a Read right/Write right and provides a right of access to the second user disk space For the client software resource without performing an authentication process for the access key.

13. The information processing system of claim 8, further comprising a read module configured to read data from a removable storage device in which a copy of a removable access key is stored,
wherein the access right control module reads the access key from the removable storage device, performs an authentication process for the read access key and provides a right of access to the user disk space for the client software resource if it is determined that the access key is valid.

14. The Information processing system of claim 8, wherein the server software resource requests the management server to provide at least one data in response to a request from the user, the management server provides the data in response to the request from the server software resource and the access right control module prepares a third disk space in which the data is stored and provides a right of access to the third disk space for the client software resource.

15. The information processing system of claim 8, wherein the server software resource performs a process of creating information of a file list stored in the user disk space of the information processing apparatus connected via the network and a process of transmitting information of the file list to the user disk space of the information processing apparatus in which the client software resource is operated in response to a request of information transmission from the client software resource, and the client software resource performs a process of requesting transmission of information of the file list to the management server.

16. The information processing system of claim 15, wherein the client software resource performs a file search process by using a name read from the information of the file list as a keyword.

17. The information processing system of claim 15, wherein the access right control module performs a process of inquiring the management server as to whether access to a file registered in the information of the file list is possible when an access request to the file registered in the information of the file list is issued from the client software resource and a process of transmitting the access request of the file to the management server when the management server permits access to the file, the access right control module performs a process of determining whether access to the file is permitted based on the user of the information processing apparatus in response to an inquiry as to whether access to the file is permitted and transmitting the result of determination, a process of making access corresponding to a type of the access request to another information processing apparatus when it is determined that access to the file is permitted and an access request is issued from the information processing apparatus and a process of transmitting the access result to the information processing apparatus.
